(19) United States
(12) Patent Application Publication
(10) Pub. No.: US 2003/0051447 A1
(43) Pub. Date: Mar. 20, 2003

(54) Apparatus and method for properly selecting and fitting articles to animals

(76) Inventor: Allison E. Bruce, Reno, NV (US)

Correspondence Address: Andrew D Gathy, Sierra Patent Group Ltd, P O Box 6149, Stateline, NV, 89449, US

(21) Appl. No.: 09/957,165

(22) Filed: Sep. 19, 2001

(51) Int. Cl. B68C 1/02

(52) U.S. Cl. 54/44.1

(57) ABSTRACT

A system and apparatus of measuring and recording the contours of a surface area of a non-human animal that receives an article, transmitting the data collected from the measuring and recordation to a remote location where the supplier of the article uses the transmitted data to select the article(s) whose contact surface area contours best correspond to the transmitted data.

In the preferred embodiment, the non-human animal is a horse; the article is a saddle; the article supplier is a saddle supplier/manufacturer; and the measuring and recordation is accomplished by making a plaster cast mold of at least a portion of the horse's back that come s into contact with the saddle. When the cast is made, it is sent to a saddle supplier/manufacturer remotely located form the horse. Once received by the saddle manufacturer/supplier, the saddle manufacturer/supplier then places various saddles on the mold so see which one(s) would correspondingly fit the best to the mold and hence, the horse. The saddle manufacturer/supplier would send selected saddle(s) which fit the best to the operator for fitting on the actual horse. Alternatively, the saddle manufacturer/supplier utilizing the mold would construct a saddle to fit the mold and hence, the horse.

In an alternative embodiment, electronic scanning equipment measures and records a three dimensional map of the contours of a surface area of a non-human animal that receives an article. The data of the three-dimensional map is then compared to the data of the three-dimensional map of at least one article under consideration for selection. Using an algorithm to compare the measured data with corresponding data from articles that are under consideration for selection. Using the comparison of data to select the article(s) whose contact surface area best matches the contact surface area of the animal. Alternately, the measurement data can be inputted into CAD-CAM manufacturing operation to custom manufacture as saddle based on the measurement data.

The invention is a business method whereby at least a portion of the surface area of a non-human animal is measured to record data about that portion of surface area using devices provided in a kit that is utilized by an individual: outside the commercial transaction of article selection; or as a service provided by an article manufacturer/supplier; or as a service provided by third parties unrelated to the individual or the article manufacturer/supplier.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND

1. Field of the Invention

This invention relates to field of methods and devices to ensure proper fitting of article to non-human animals. In particular, the art of properly selecting and fitting a saddle to a horse's back.

2. Description of the Prior Art

Even since the first domestication of the horse that occurred epochs ago, equestrians have enjoyed the pleasure of riding on horses even when it was a necessity of everyday life. From such equestrian activity, derived the development and use of the saddle for horseback ridding. Created to give comfort and control to the rider, the saddle is designed to be mounted on the horse so that the saddle contact areas, located on the underside of the saddle, rest on the muscles along side of the horse's spinal column (18 thoracic vertebrae) including a portion known as the withers, a portion of the rib muscles and a portion of the scapula (shoulder) muscles. In particular, the muscles affected by the placement of the saddle include the trapezius muscles 22, longissimus dorsi 23, and the latissimus dorsi 24.

The proper mounting of the saddle allows the horse to be comfortable in supporting saddle and rider by evenly distributing their weight over the back of the horse. This weight distribution is very important to ensure that the saddle does not impede the athletic movements of the horse. The weight and pressure of the rider must be distributed evenly upon the horses' back so as to prevent any saddle-horse contact areas from causing the pinching of horse or having any unwanted gaps between the horse-saddle contact areas.

If the weight of saddle and rider are not well distributed through saddle-horse contact area, then the contact area of the saddle becomes focused pressure points digging into the contact area of the horse. Such occurrences can be very painful to the horse, bad posturing and improper gait as the horse tries to alleviate the pain. Long-term occurrences can lead to saddle sores and downright hostility by the horse to saddle and the rider.

The established methodology of properly fitting saddle is a cumbersome, time consuming and expensive endeavor. First, the saddle must be obtained and then placed on the horse's back for evaluation of its fit to the horse. Second, the rider then mounts the horse via saddle and rides the horse to see how well the saddle to horse fit is during riding.

During the first step, it has been a consistently rare experience that the first “off-the-shelf” saddle would fit when it is applied to the horse. This experience occurs since a) the back of the horse has many contours which individually differ based on characteristics such as breed, musculature, age and bone structure. It is much like how the feet of a person are different from those of others, in that no one pair of shoes would comfortably be worn by everyone. b) There are a wide variety of saddle shapes and sizes to try to compensate for the wide variety of horse shapes and sizes. Accordingly, there is no such thing as a “one-fits-all ” saddle.

The first step is all about trying to find a saddle with the right fit to the horse. This step presently requires that a person try on the horse as many saddles, with a variety in shapes and sizes, as is necessary to accomplish this step. Due to the wide dispersement of purveyors of saddle (tack suppliers), the equestrian has utilized a wide variety of shopping means for contacting faraway saddle sources so as to procure a great variety of saddles that are to be selected for fit mounting on the horse.

This fact in itself possesses a problem in that the current wholesale/retail saddle supply system simply lacks adequate single location distribution points (i.e. tack stores). The single location distribution points that do exist simply lack the resources to afford, support, or even manage a large inventory of high priced, large sized goods such as saddles akin to the size of inventory as utilized by a large shoe store. There are very few tack stores, and even fewer custom saddle makers or fitters, that are able to keep moderate sized inventory of expensive goods such as saddles. The drive to obtain a proper fitting saddle causes many equestrians to travel great distances, even abroad, as well as searching through catalog or on-line shopping to find the golden fleece of saddles for their beloved mounts.

The remote selection through catalog and on-line shopping, while solving the issue of saddle variety, brings to the forefront the difficulty of obtaining a proper fit. Once an equestrian elects to purchase through the mail or on-line, the biggest challenge typically involves deciding which saddles to try first. The decision for many is a random one, since it is likely that a salesperson is many miles away from horse and as such has not likely to have seen the horse. At the same time, the consumer, also many miles away from the saddle, has not seen the contours of the saddle. The result of this situation being that neither person will have any solid idea how well a particular saddle will fit the particular horse.

As stated above, the challenge lies with each horse's back being different. An additional challenge is trying to accurately measure and transmit to a remote location either, or both, the contact areas of the saddle and the contact area of the horse so that remote selection and fitting of saddle to the horse would be successful.

Currently, within the stock retail industry the most common method of providing a measurement for remote transmission is to use a withers tracing. However, the withers tracing method is very limited in that it only measures and allows the recordation of certain points on the horse's back contour, rather than taking all the contours of the horse's back. As such withers tracing only provides a hairpin fraction of the information needed to make a thorough evaluation of saddle-horse fit.

Withers tracing is accomplished by using a straightened coat hanger, the “True Fit Saddle Fitting™” Kit, or a “Flexicurve™”, found at art stores, as they are all similar in function. The consumer bends any one of these tools across the back of the horse along the right and left side of the withers to measure only a small part of the withers area. The new shape of the tool is then traced on a piece of paper. This tracing is cut out and held to the underside of the saddle to determine fit for that particular area of the horse.

Other related art for measuring the withers of any horse for any saddle is the Wintec™ Gullet Gauge. However, this tool is proprietary in that its sole purpose is for adjusting the makes of saddles manufactured by Wintec™. As with the coat hanger and Flexicurve™, the Wintec Gullet Gauge™ lacks the ability to comprehensively measure the entire area of the horse's back on which the saddle rests. Thus, it is not a viable apparatus since it relies on point-to-point measurement methodology rather than area to area, for obtaining a proper fit.

Finally, in the custom saddlery field, some custom saddle makers have designed similar tools to the Flexicurve™ that help them or their customers take measurements for custom designing a saddle. The Barnsby™ Leather Measure, the Leather Wire Tracer™, and the SaddleTech™ are three such tools.

The Barnsby™ Leather Measure and the Leather Wire Tracer™ are essentially leather versions of the Flexicurve™. Custom saddlers take several measurements with such tools, not just the withers measurement. Each measurement is a calculated distance from the one before it. These calculations are then compiled as a whole and translated via formulas into a form that represents the contours of the horse's back. The custom saddler's method for taking such measurements is a precise one, and typically requires some advanced skill and training. While the custom methodology of measuring a horse's back is more comprehensive than the withers tracing, still relies on point rather than area measurement. Furthermore, the process of compiling, preparing and interpreting information obtained by this system is generally beyond the grasp of the untrained average saddle consumer.

The Saddle Tech™ is another measuring tool used in custom designing saddles that allows a saddler or the customer the ability to take seven specific readings, by way of dials. While this tool can measure the point of the withers, as well as the points just behind them, it still relies on point, rather than an area, measurement.

As demonstrated above, the prior art measures only specific points of measurements rather than taking measurements and record data collected from surface areas of the non-human animal. As such, the above described tools are therefore limited in their measure capability in taking into consideration only very limited aspects of the horses' backs and as such, fail to take into consideration additional non-wither surface areas of the horse that are also important to the successful fitting of a saddle to a horse. These additional surface areas which also impact the fitting of the saddle include: the shoulder blades, spinal area and musculature on the top of the back. These additional areas include non-contact surface areas in that there are portions of the horse's back should have free clearance from the physical encumbrance of the saddle.

The ideal fitting service would comprise of bringing the horse and potential pre-made saddles for sale/saddles made for order together for a “hands-on ” custom fitting comprising of two phases. The first phase would comprise of the placement of one saddle on the horse at a time. The saddle-to-horse fit would be checked at several contact surface areas and several non-contact surface areas. These areas include, but are not limited to:

(a) The gullet 41 of the saddle width must be wide enough not to interfere with the spinal process or musculature of the horse's back.

(b) The pommel 31 of the saddle must clear the withers by approximately 2-3 fingers.

(c) The panels 36 of the saddle must have full contact and should touch the horse's back evenly all the way from front to back and should not bridge or rock.

(d) The front contact areas of the panels 36, as they represent the front portion U-shaped portion saddle tree 46 as padded by panel, should be flush with the horse's shoulders to position and support the saddle properly.

(e) The billet/girth straps 45 should hang perpendicular to the ground so that the girth is not angled.

(f) The saddle's seat area 33 should lie parallel to the floor on the horse's back.

(e) The saddle should be straight and not fall off to one side when viewed from back of the horse and the front panel points of the saddle tree 46 should be behind both shoulder blades.

The second phase would have the rider then mount the saddled horse and put the horse through its paces while being observed by an experienced fitter to see how the saddle moves and gives on the horse while in movement and under weight of the rider. The fitter would ensure that as the horse is being put through its paces by the rider, that the saddle is seated properly, and does not impinge on areas of the horse that should be free of contact from the saddle during movement.

This second phase being applied to the shoe fitting of a person, would be analogous to having the person walk in the pair of shoes selected for purchase to insure that the inseam and toe area of the shoes were of the proper fit while walking.

Failure to properly fit the above specific surface areas would result in an ill-fitting saddle. One example is that a saddle may be too narrow in between the panels. In this case, the saddle will cause deep muscle pressure and pain to the muscles along the spinal area. Another example is where a saddle may be too curved along the length of its underside. If it is too curved (or the horse has less curve than the saddle), the saddle is called a “rocker” since it will rock back and forth, placing too much pressure on the center of the horse's back. If a saddle is too flat (or the horse has more curve than the saddle), the saddle is called a “bridger” since it cannot absorb any weight in the center and causes too much pressure on each end of the horse's back. All of these conditions are uncomfortable to the horse and can cause the horse to obtain poor posture to avoid the discomfiture. Long term usage of such a saddle may cause chronic pain and medical disability to the animal.

The inflected pain caused by an ill-fitting saddle will impact on the ability of the horse to perform to its greatest ability. In these cases, a horse's behavior typically becomes sour and the horse will become tense, angry and unwilling to perform as trained in an attempt to escape the pain of the weight on its sore back. At this point, the ill-fitting saddle not only becomes a danger to both horse and rider. An ill-fitting saddle also leads to extra expenses related in finding medical treatment for the physical disabilities imposed by an ill-fitting saddle.

Once a consumer makes the initial decision of which saddles to try first, the next challenge is deciding which ones fit properly, if any, after they arrive. Upon arrival, the consumer must place the saddle on the horse's back and evaluate it. However, since many horse people are not educated in how to evaluate the fit of a saddle, the uneducated consumer is left in the undesirable position of making a decision of whether it fits properly. If the consumer makes the mistake of buying a saddle that does not fit, it is inevitable that the need to find a proper fit will arise again. Furthermore, if a consumer tires of present remote fitting process using today's fitting technology, and compromises with a saddle that appears to fit, the question still remains, “Is there one that fits better?” While a saddle might appear to fit well, there may be one that fits better, still sitting on the shelves back at the warehouse that was never even tried.

If a saddle does not fit, most mail-order policies state that the saddle may be returned, as long as it does not show usage, for a full refund minus the shipping charges. For each saddle that does not fit, the consumer typically incurs shipping charges to receive the saddle plus shipping charges to send it back in addition to paying the full price of the saddle during the time it was away from the saddle supplier. Shipping charges range from $20 to $25 each way. Saddle costs range from $500 to $3,800. Many consumers have been known to try anywhere between three to twelve saddles through mail order before either finding one, or giving up on the mail order system.

In the custom saddle making industry, if a saddle that has been made does not fit, it is likely that the customer will have to ship it back for adjustments until it does fit or find another fitting alternative.

Thus, a proper fit is crucial, and while the point measurement approach is sometimes used by stock retailers, it does not provide the detailed measurement of the entire area on which a saddle rests, nor does it provide a complete detailed measurement of the underside of the saddle. Under this current system, the random nature of selecting or custom making saddles based on an incomplete measuring method, exacerbated by the costs of shipping, typically prohibits many consumers from trying as many saddles as they should and limits the selection that is commercially available. As a result, consumers are left frustrated by the system, as they can never fully be certain that a saddle purchased is the best match through that particular saddle supplier.

What is needed is a measurement apparatus and system that maps the specific area in question as an entirety and is easily transmitted to remote locations for initial selection and/or final fitting of a saddle. The area to be mapped could be either the contact areas of the article or the animal or both. This methodology and apparatus could be applied to article fitting to a wide variety of non-human animals.

### SUMMARY OF THE DISCLOSURE

The present invention is concerned with the apparatus and methodology of fitting articles to non-human animals and the remote transmission of the data collected by that apparatus and methodology. In the preferred embodiment, the invention is used for properly selecting and fitting a saddle to a horse, specifically through streams of commerce such as catalog, online, and other remote suppliers wherein the horse is not available for the physical fitting of the saddle.

The apparatus in one embodiment is a kit that comprises of a box with suitable advertising and instruction indicia. The box contains several plaster splint sheets, essentially plaster of Paris impregnated cloth or gauze strips for casting a mold of the horse back, a roll of several strips of cotton gauze placed in between the horses back and the plaster splint sheets, a pair of handling gloves for handling plaster splint sheets, detailed instruction for use, both in written and video format, and a shipping-delivery and identification card to ensure proper delivery of the recorded measurements (mold).

The operator uses the kit to make a three-dimensional map or a mold of the horse's back. The operator first secures the horse and provides treats, food, water for the horse to keep it comfortable and still. An assistant in this process is most helpful to tend to the horse. The operator dons the plastic gloves and spray wets the cotton padding strips. The wetted cotton padding strips are laid widthwise over the horse's back so as to evenly lay on the top of the horse's flanks. The operator lays the first cotton padding strip on the horse's starting on the horse's withers and proceeds in an overlapping fashion to the hindquarters until reaching the last rib of the horse. The plaster splint sheets (strips) are wetted two at a time and are placed in an overlapping fashion over the cotton padding strips widthwise over the horses back so that wetted plaster strips are draped evenly over the horses back just covering the cotton padding strips. After ten to fifteen minutes, the cast or mold has sufficiently cured to be removed from the horse's back. Once the cast has initially dried, it is removed from the horse and placed on a saddle rack to complete the drying, generally within 72-hours (four days). Once fully cured, the molding of the back area of the horse can be delivered to remote saddle suppliers for matching up of the saddle to the cast. The selection of close fitting saddles is made using the cast and those selected saddles are forward on to the user of the kit so as to be tried on by the mount.

Additional embodiments would use electronic three-dimensional mapping technology in place of the casting materials, wherein a scanner electronically measures at least a portion of the external surface horse's body, translates that measurement into data that can be transmitted to a site remote from the measuring source.

The measurement of the portions of surface area of the non-human animal, either electronic or physical, can be accomplished by the horse owner who can purchase the invention from remote saddle suppliers/manufacturers or other third parties, or a system of measuring stations either as part of the saddle supplier/manufacturer's place of business or at equestrian events or even as a mobile unit. It is further seen that the invention can be supplied as a part of e-commerce business where the transaction is carried through a web portal such as a fully transactional website.

Although a horse is used as the primary example, the invention could be applied to other non-human animals as well for helping the proper fitting of the article to be worn by non-human animals.

Although the primary example shows that the operator being the purchaser of the article, the manufacturer could also use the same methodology to make lightweight, inexpensive, less bulky molds or castings of the contact surfaces of the articles that the manufacturer sells or distributes. In this way, the distributor/manufacturer could send molds of his articles for sale to a prospective purchaser as an aid to select which wares would best fit the non-human animal. Due to their lightweight construction, smaller size, and inexpensive cost, a distributor could maintain a large inventory of such molds of articles much more easily that could be maintained of the actual article. This large inventory of castings/molds would facilitate the proper fitting, hence would result in greater quantities of articles having to stock a large inventory of the actual articles themselves. Once the proper fitting by mold had been accomplished, the prospective purchaser would return the molds/castings to the manufacturer/distributor. Based on the information gathered by the use of the molds/castings, the proper fitting article could be sent to the purchaser.

It is an object of the invention to provide an easy method of taking a three dimensional measurement of the surface area horse's back that does not require the skills of an expert in the field to perform.

It is an object of the invention to provide a measurement that, in its three-dimensional form, mirrors most, if not all, contours of the surface area from which it was taken.

Its is an object of the invention to provide a cost-effective, timely and efficient fitting system by which data is created to describe the three dimensional profile of at least a portion of a surface area of an animal that comes into contact with the article.

It is an object of the invention to provide a reliable, easy to use means of transmitting to a remote location a three dimensional profile of a surface of a non-human animal for use in remote selection of articles to be applied to the animal at the area measured.

It is an object of the invention to provide a remote supplier of articles worn by non-human animals with three dimensional profile data that promotes selection of article that best fits the subject non-human animal.

It is an object of the invention to provide a fitting system that incorporates an experienced saddle fitter who can help a consumer evaluate whether a saddle fits; and

Further objectives and advantages are to provide consumers with a means of providing a complete three dimensional profile measurement to be used by custom saddlers as well as stock saddle suppliers. Further objectives and advantages will become apparent from a consideration of the ensuing description and drawings.

### DESCRIPTION OF THE DRAWINGS

FIG. 1 shows a side view of a horse.

FIG. 2 shows a side view of a portion of the horse's skeletal structure.

FIG. 3 shows a side view of a portion of the horse's musculature with an outline of the proper placement of a saddle.

FIG. 4 shows a perspective view of a saddle.

FIG. 5 shows the underside of the saddle.

FIG. 6 shows a partial cutaway view of a saddle.

FIG. 7 shows a perspective view of the kit embodiment of the invention.

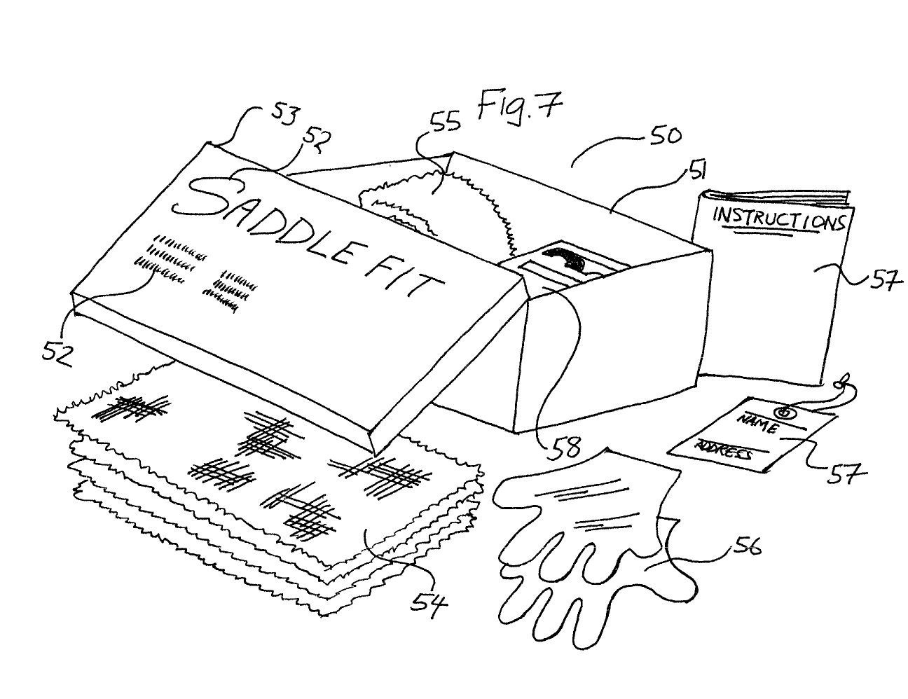

FIG. 8 shows a side view of the application of the protective layer strips.

FIG. 9 shows a side view of the application of the molding material.

FIG. 10 shows a side view of the removal of the initially dried mold.

FIG. 11 shows the mold being used to test saddles for proper fit.

### REFERENCE NUMERALS IN DRAWINGS

1 Invention

10 horse

11 body

12 neck

13 withers

14 hollow area below the withers

15 shoulders

16 curvature of the back

17 croup

18 hindquarters

19 spinal column (18 thoracic vertebrae)

20 ribs

21 scapula/shoulder blade

22 trapezius muscles

23 longissimus dorsi

24 latissimus dorsi

30 saddle

31 pommel

32 twist

33 seat

34 cantle

35 skirt

36 panel

37 knee roll/pad

38 saddle flap

39 stirrup iron

40 stirrup leather

41 gullet

42 channel

43 sweat flap

44 lining

45 billet/girth strap

46 saddle tree

50 the kit

51 box

52 lid

53 advertising and information indicia

54 plaster splint sheets

55 roll of cotton padding

56 handling gloves

57 detailed instructions

58 video instruction tape

59 identity tag

60 mold

61 saddle rack

### DETAILED DESCRIPTION OF THE PREFERRED EMBODIMENT

The invention, generally referred to as numeral 1 is an apparatus and method of obtaining data of a full three dimensional profile of a surface area of a non-human animal, transmitting the data to a remote supplier of articles that are applied to the measured surface area, using the transmitted data by the remote supplier to selecting or creating articles requested that best fit the subject animal based on the presented. Forwarding the selected articles to the operator who initially obtained and supplied the transmitted data to the remote supplier or the individuals who are using the operator's services to get the measurements. In the present case, the remote supplier can be either or both the manufacturer and distributor.

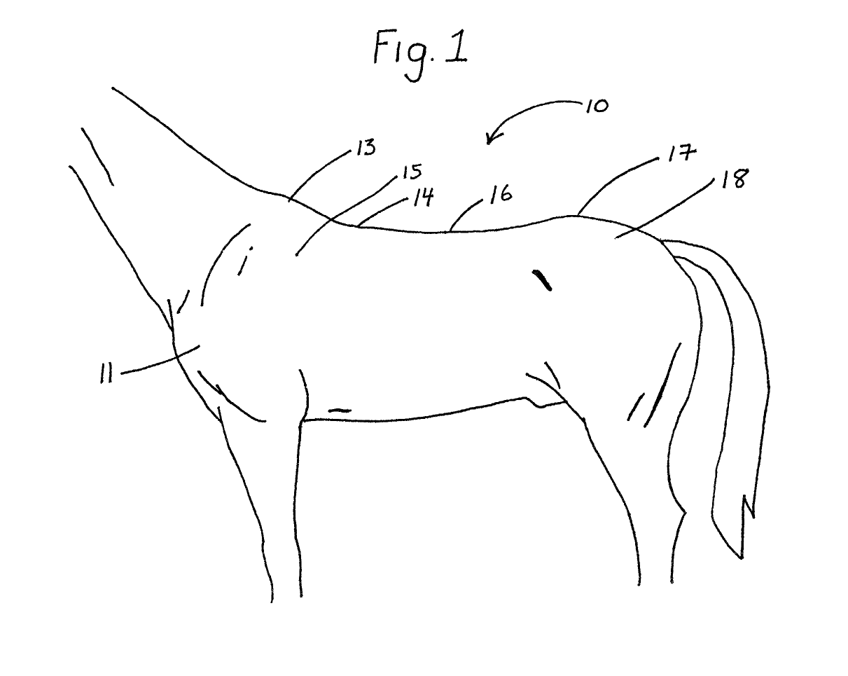

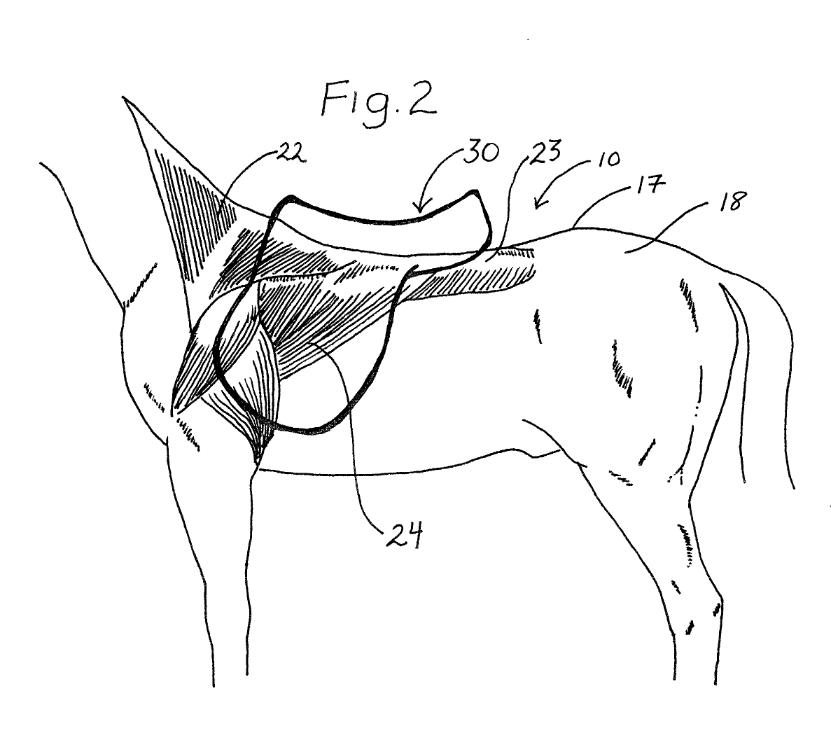

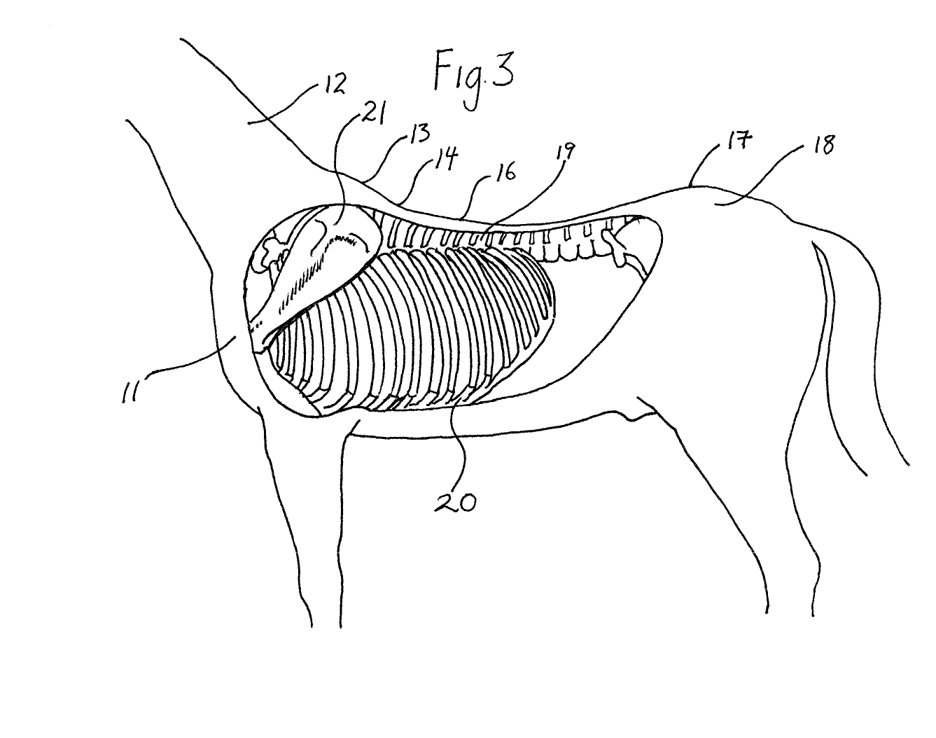

As shown in FIGS. 1, 2 and 3, the preferred embodiment's subject/non-human animal is a horse 5, but its is understood that the invention 1 can be applied to a wide variety of non-human animals. The horse, general referenced by numeral 10, has a body 11 of which there are certain identifiable surface areas: the neck 12, the withers 13, the hollow behind the withers 14, the shoulders 15, the curvature of the back 16, the croup 17, and the hindquarters 18. The important skeletal structures in fitting a saddle are the horse's spinal column (18 thoracic vertebrae) 19, the ribs 20 and the scapula (shoulder blade) 21. The horse's muscles that are directly affected by the placement of the saddle include the trapezius muscles 22, longissimus dorsi 23, and the latissimus dorsi 24. The saddle, generally referenced by numeral 30, whose outline on the horse 10 is shown in FIG. 3 shows the proper placement and positioning of the saddle 30 on the horse 10.

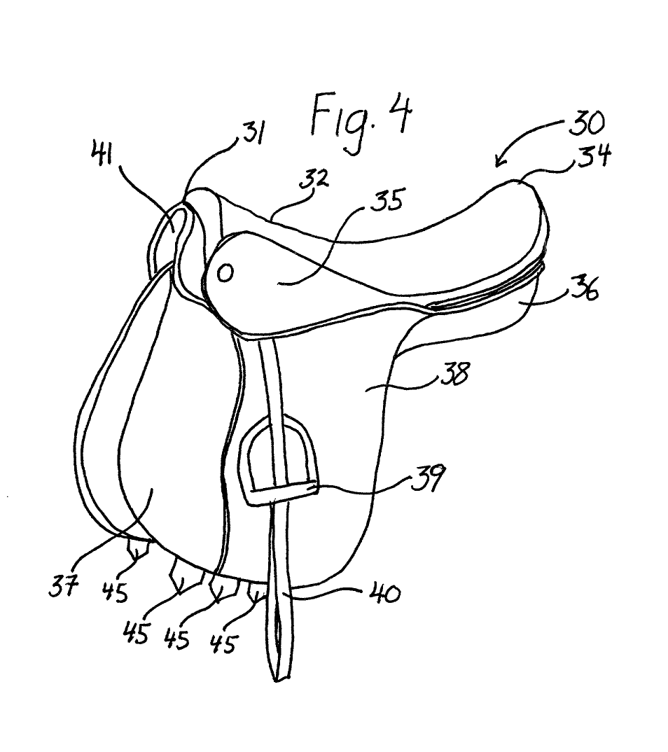

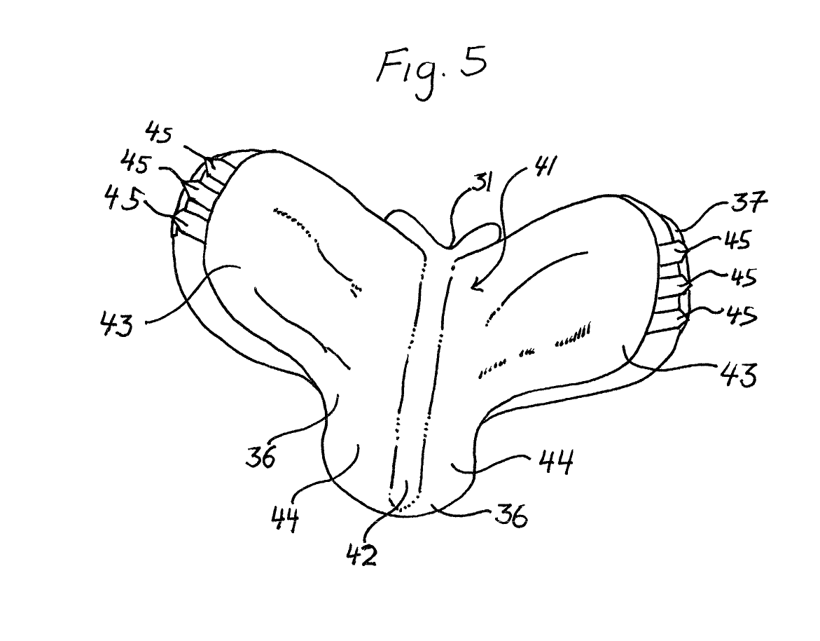

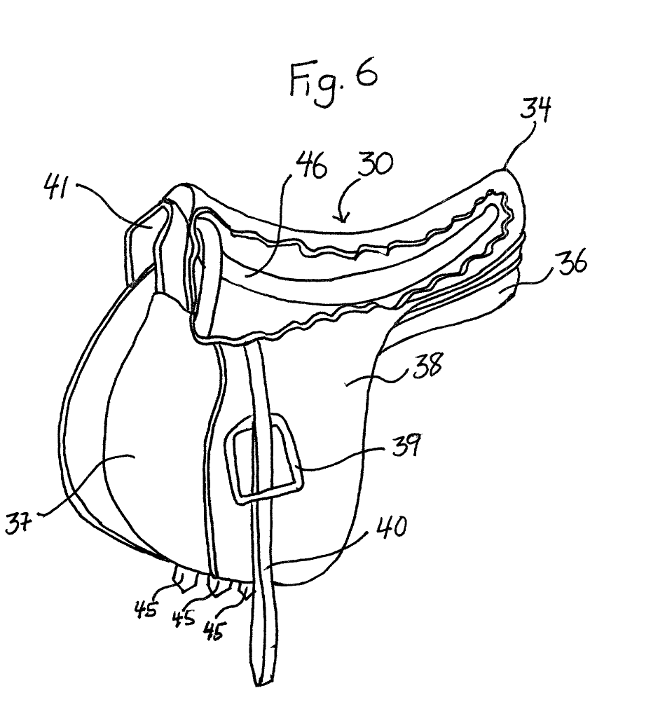

As shown in FIGS. 4, 5 and 6, the article to be selected in this particular embodiment for fitting is a saddle 30, although other articles may be similarly selected and fitted by the invention 1. The saddle 30 is generally of two types, English or Western, with each type have several sub-variations that are designed for specific types of horseback riding. In the present embodiment, an English saddle is used, although a western saddle can be selected and fitted using the invention 1 as well. Further, the English saddle, due to its usage and construction, requires a greater amount of detail to be given to its selection and fitting to a horse than does the western counterpart.

Outer portion of the saddle 30 comprises of such elements as the pommel 31, the twist 32, the seat 33, the cantle 34, the skirt 35, the panel 36, the knee roll or pad 37, the saddle flap 38, the stirrup iron 39, the stirrup iron 39, the stirrup leather 40. The underside of the saddle is generally comprised of the elements the gullet 41 (the hollow underside of the saddle over the spinal column 19), generally denoted by numeral 41, the channel 42, the sweat flap xx, the lining 44, and the billet/girth straps 45. The interior of the saddle 30 comprises of the non-flexible saddle tree 46 which gives the rigid support to the saddle 30 and ensures that the weight of the rider is properly directed to the flexible elements of the saddle 30. It should be noted that the basic componentry of the English saddle have an analogous structures found in the Western saddle as well.

As described above, the contact/non-contact areas of fitting would include, but are not limited to:

(a) The gullet 41 must be wide enough not to interfere with the spinal process or musculature of the horse's back 16.

(b) The pommel 31 must clear the withers 13 by approximately 2-3 fingers.

(c) The panels 36 must have full contact and should touch the horse's back along side its thoracic spine 16 evenly all the way from front to back and should not bridge or rock.

(d) The points of the front panel, as they represent impact areas of the front U-shaped portion of non-flexible saddle tree 46 as padded by panel 36, should be flush with the horse's shoulders 15 to position and support the saddle 30 properly.

(f) The billet/girth straps 45 should hang perpendicular to the ground so that the girth which is the strap going around the belly of the horse 10 to attach to the billet/girth straps 45 is not angled.

(f) The saddle seat 45 should lie in parallel to the horse's back 16.

(g) The saddle 30 should be straight and not fall off to one side of the horse 10 when viewed from back of the horse 10 and the points of the panel 36 where the saddle tree 46 contacts the panel 36 should be behind both shoulder blades 21.

Although the invention 1 is an apparatus and methodology of fitting articles to non-human animals utilizing full three dimensional measurement of the measured contours of either the non-animal or the article or both, and transmitting the measurement data to a remote site for utilization in selecting and fitting of an article to be applied or worn by the non-human animal applicable and adaptable to a wide variety of situations, the preferred embodiment of the invention 1, is a kit, generally reference by numeral 50 used to select and fit the saddle 30 to a horse 10. The kit 50 is used in the first phase of saddle fitting to ensure that a saddle when first selected for fitting has a very close fit to the horses back 16. The kit 50 comprises of a box 51 with advertising and information indicia 52 and an openable or removable lid 53. The box 51 contains 1) several plaster splint sheets 54, essentially plaster of Paris impregnated cloth or gauze strip, 2) a roll of cotton padding 55, 3) a pair of handling gloves 56, 4) a detailed written operating instructions 57, 5) a video tape 58, and 6) identification card 59 for the completed mold 60 to ensure proper transportation of the mold 60.

The operator uses the kit 50 to make a casting of a three-dimensional mold 60 of the horse's back 16. The operator, in order to have a quiet, non-moving horse 10 during this procedure, first exercises the horse 10. The operator then secures the horse 10 by its halter to a crossties so that the horse 10 is standing squarely on even ground. Then the operator secures water, food, treats and necessities to keep the horse 10 comfortable, and hence still during the process. An assistant in this process is most helpful to tend to the horse 10. The operator then secures scissors (for cutting the roll of cotton padding 55 and plaster splint sheets 54 into strips), a bowl of water (for wetting the cast splint strips), and a spray bottle (for lightly wetting the cotton padding strips).

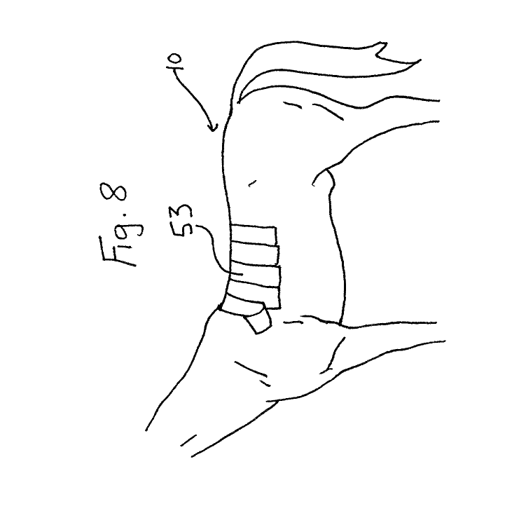

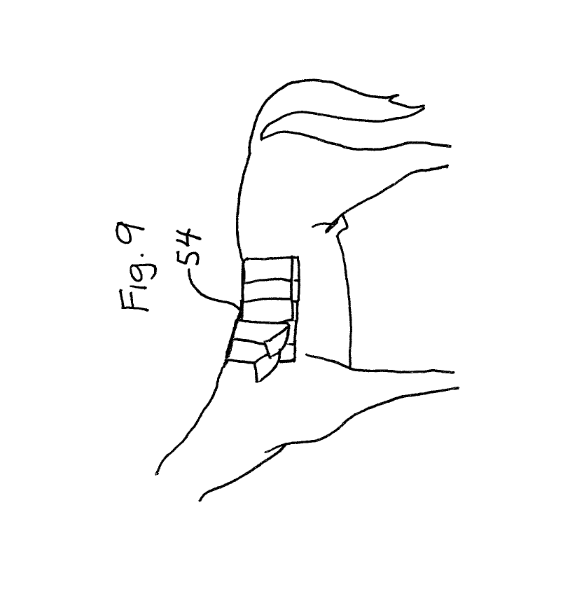

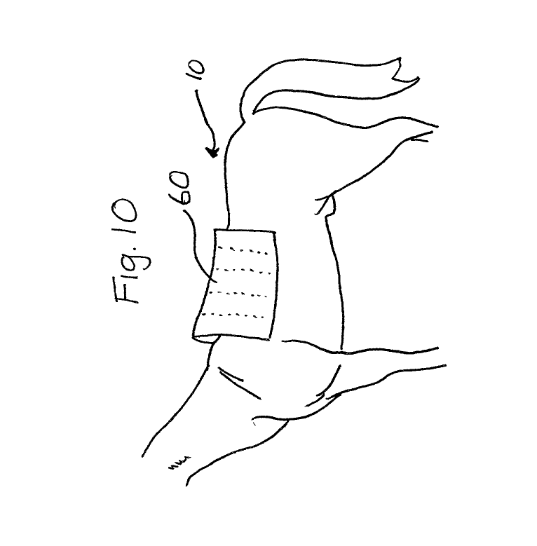

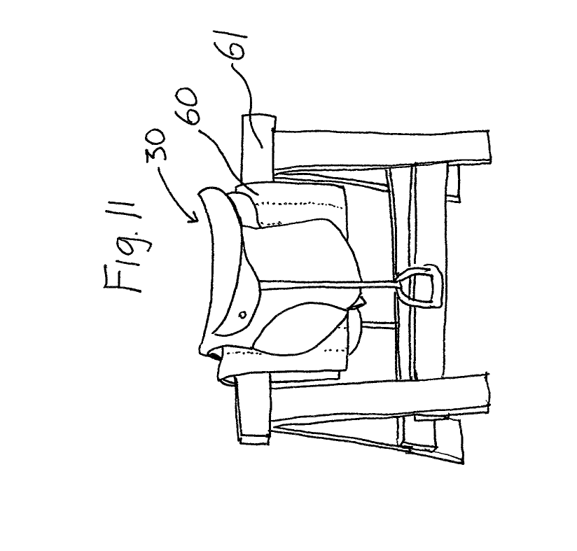

As shown in FIGS. 8 to 11, before the casting material (of wetted strips of plaster strips) is applied, a thin protective layer is need to applied to the horse's back to prevent direct application and hence adhesion of the casting material to the horse's hide, and further protects the horse 10 from the discomfort of heat that is given off by the casting material during the curing process. In the preferred embodiment, the protective layer comprises of strips of cotton padding 55 or any other suitable material that can serve as a protective layer, as long as it is thin and slightly stretchable and does conduct heat.

The operator dons the handling gloves 56 (which can latex type gloves or a suitable substitute) and spray wets the individual strips of the cotton padding 55. The spray wetting helps the cotton padding 55 to adhere to the back 16 of the horse 10. The operator then individually lays the wetted strips of cotton padding strips 55 in an overlapping fashion, side by side over the horse's back 16 widthwise. In this manner, the strips of cotton padding 55 are applied to the width of the horse's back 16 so that the ends of the strips drape onto the top portion of the horse's flanks. The overlap of the cotton padding 55 should be enough to ensure complete coverage of the area of the horse's back 16 to which the molding material will be applied. The operator lays on the first strip of the cotton padding 55 on the horse's back 16, starting with the horse's withers 13 and proceeds in an overlapping fashion towards the hindquarters 18 until reaching the last rib of the horse 10.

After placing protective padding in place, the operator then cuts plaster splint sheets 54 into strips. Taking two of these strips 55 by their ends and holding them side-by-side in an overlapping fashion, the operator the moves the strips through the bowl of water to wet the plaster of Paris contained in the strips. The operator then places the two wetted strips of the plaster splint sheets 55 in their overlapping fashion over the cotton padding 55 so as to following the same widthwise orientation of the strips of cotton padding 55. This process is repeated just until the last wetted strip of the plaster splint sheets 54 is applied. At that point, the operator fills out the kit-provided identification tag 58 and then attaches the tag to the mold 60 when the she puts in place the last strip of plaster splint sheet 54.

The applied strips of the plaster splint sheets 54 are then massaged lightly into the contours of the horse's back 16 until the entire mold 60 is semi-dry and can be lifted away from the horse's back. 16.

The area covered by the mold 60 is approximately 30″×22″ and includes coverage of the area comprising: the withers 13, the hollow area below the withers 14, the shoulders 21, and the curvature along the top the horse's back 16. The one end of the underside of the mold provides the recording of the contour taken of the horse's withers 13. Just behind that portion of the mold is the recordation of the contour of the hollow behind the withers 14, and just below and behind that area is the contour taken of the horse's shoulders 21. The rear portion of the underside of the mold contains the record of the contour of the curvature of the horse's back 16. The completed mold 60 includes the above-mentioned contours and connecting contours of the horse's back 16.

The completed mold 60 should only be about a quarter inch thick to best represent the recorded contours of the horse's back. This quarter inch thickness does not obscure the horse's contours since this is the approximate thickness of most horse blankets or pads that are used in between the horse's back 16 and the saddle 30. Horse blankets/pads are placed on the horse's back when fitting a saddle to the horse's back 16.

After about ten minutes, the strips of plaster splint sheets 54 have sufficiently cured and have solidly attached themselves to the protective layer of cotton padding strips 55 to form a mold 60 of the horse's back 16. Once the mold 60 has initially dried, it is removed from the horse 10 and placed on a saddle rack 61 to complete the curing process within 72-hours (four days).

Once fully cured the mold 60 of the horse's back 16 can be delivered to remote saddle suppliers/manufacturers for matching up of the saddle 30 to the mold 60. This is accomplished easily by packing the mold 60 into an acceptably sized box filled also with packing materials. Sealing the box, obtaining proper postage and insurance, the operator sends the mold 60 to a desired saddle supplier/fitter who is remotely situated from the measured non-human animal.

In alternate embodiments, the mold 60 can be made from any other molding material that, once set, may be slightly flexible, without losing its intended shape, is light-weight, safe to use on animals, and approximately ¼″ or less thick. Other molding material includes, but is not limited, to laminated fibrous materials, various plasticized or rubberized materials, and other forms of plaster, polyester, or fiberglass materials.

The remote supplier/manufacturer fits the various articles in his inventory, that are under consideration for selection based on the instructions from the operator, to the mold 60 In this way, the mold 60, in providing a full three-dimensional profile for fitting, allows the supplier or manufacturer or fitter of the saddle the option to eliminate from consideration, and hence transport, any poor fitting item of the articles being considered. The mold 60 also allows the selection and forwarding of those articles, if any, which would closely match or properly fit the mold 60 and hence the non-human animal.

Additional embodiments of the invention would use electronic three-dimensional mapping technology in place of the casting materials, wherein a scanner electronically measures the contact surface area of the non-human animal's body to which the article would be fitted. An example of this is a wand-like scanner known under the trade name of “TRACER-CAD®”. This specific device is waved over the surface area being measured to electronically scan to translate the three-dimensional area into electronic data. This three-dimension map data can then be compared to a corresponding three-dimensional map data obtained from articles under consideration for selection utilizing CAD/CAM (Computer Aided Design/Computer Aided Manufacturing) technology that is well known to those versed in such art. Using computer-imaging capability, the transmitted data can be compared to measurement data stored in a CAD/CAM electronic system of the articles selected to be purchased. This can be accomplished utilizing an algorithm to compare the two sets of measurements and then either accept or reject the article under consideration for selection depending on whether the correspondence between the sets of data is within an established range(s) or a set of previously fixed parameters. When an article is selected as being suitable to fitting the measured non-human animal, the article is forwarded or transmitted so that it can be placed on the measured non-human animal that is remotely located from the supplier.

Additionally, the CAD/CAM system of comparison could be used to make changes in or actually construct the article to increase the fitting compatibility of an article to the measured non-human animal's contours. For example, the saddle tree 46 is considered the most important aspect of the saddle construction in determining the shape and form of the contact surface areas of the saddle 30-. The padding surrounding or underlying the saddle tree 46 is considered to be of secondary importance for fit. The measurement data obtained from the horse 10 could be used to set the specifications of the tree saddle 46 that is to be incorporated into the saddle 30 being built for the horse. In this means, the saddle tree 46 itself, and hence the overall fit of the saddle 30 is made to fit the counters of the contact surface area of the horse 10.

The comparison of the two sets of data could be accomplished in several different means. First, the data of the measured non-human animal could be transmitted to the supplier/manufacturer of the article. The supplier/manufacturer would then utilize the data to make the appropriate comparisons needed for the manufacture or initial selection of articles that are available from that supplier/manufacturer.

Second, three-dimensional map measurement data for a multitude of articles available from several suppliers/manufactures (i.e., a catalog database) could be located with a third party. An operator of the invention would send measurement data of the non-human animal plus instructions regarding the articles or types of articles under consideration for selection to the third party. The third party would then compare the three-dimensional data sent by the operator with that data contained within its catalog database to determine which of any articles represented in the database suitable match the measurement of the non-human animal. The third party could then forward the location/purchasing information of the suitable article (s) to the operator to allow the operator to make the final selection and/or ordering of the desired article(s). The third party could also handle the selection of the desired articles by contacting the supplier/manufacture of the selected article to cause the transmittal of the selected article(s) so that it could be forwarded for final fitting upon the measured non-human animal. The third party could also arrange and handle all the commercial transactions that occur between the operator and the suppliers/manufactures of the article.

The third party location and data base could be accomplished through a Internet based or other computer network linkage web portal with suitable backend capability of handling the data storage, data receipt and transmission, processing of article selection services, ordering articles from article suppliers/manufactures, and the business accounting and inventorying needed to run the business.

A further refinement of this embodiment of the invention 1 would be having the third party supply the scanning equipment for the measurement of the non-human animal. This could be done through trailing the equipment to the location of the remotely located non-human animal. This could be also accomplished by setting the scanning equipment in a kiosk at locations frequented by the non-human animals such as agricultural stations, veterinarian offices, state fairs, and other areas (horse shows, training facilities, auctions, meets, tack shops etc.). This activity could give rise to franchise method of business whereby franchisees would transport or set up scanning equipment and transmit the recorded measurements to the franchisor. The franchisor would then handle the processing of the measurement data; the data storage of the measured articles and the comparison and selection of the desired article(s); transport of same for fitting on remotely located non-human animal; and the commercial aspects between operator and the supplier/manufacturer of the selected article(s). The franchisee would receive a commission from completed sales.

Another embodiment of the invention 1 would be the apparatus and methodology of creating a three-dimensional mold of the contact surfaces of the article. This mold, which could be made using CAD/CAM technology, could be quickly and inexpensively made through various manufacturing means such as injection molding and the alike. This would allow a supplier/manufacturer to maintain a large inventory of cheap, light weight, easy to store, easy to transport casts (instead of bulky, heavy and expensive saddles) that could be shipped to for fitting on a non-human animal that is remotely located from the supplier/manufacturer. In this manner, a set of molds representing a set of articles could be sent to the operator for fitting to the non-human animal to determine which if any of the represented articles would best fit the non-human animal. The operator would make a decision on the fitting of the molds and then return the set of molds back to the supplier/manufacturer of the represented set of articles. Selected articles would then be forwarded by the supplier/manufacturer for final fitting upon the non-human animal.

Further, invention 1 provides a methodology of increasing the efficiency of a business that is in the sales, distribution or manufacture of articles requiring fitting for a sale or purchase. This efficiency is obtained through reducing the amount of capital needed to maintain or obtain access a large on-site inventory necessary to conducting fitting of the articles as needed for the sale of the article. Since invention's methodology of utilizing non-human animal molds and/or article molds and/or the use of electronic scanning technology and/or CAD/CAM comparison of measured data would reduce or eliminate the need for a large on-site inventory required to conduct the necessary fitting for the sale or purchase of the articles. The invention 1 allows operators of the invention 1 to direct to other commercial needs, the capital that otherwise would be used to acquire, build-up or maintain an article inventory. Instead of maintain a large inventory of articles, business operators could rely on the much more inexpensive article mold inventory or rely on real time article supply/manufacturing combined with scanning/CAD/CAM data measurement and comparison technologies. This elimination/reduction of capital requirements for inventory asset management would allow smaller capitalized company operators of the invention 1 to be able to generate the sales of articles and the business that was previously only obtainable by large well funded well-capitalized companies that could afford to maintain large article inventories.

Although a horse is used as the preferred embodiment, the invention 1 could be applied to other non-human animals as well to assist in obtaining a proper fit of article to be worn by non-human animals.

While these descriptions directly describe the above embodiments, it is understood that those skilled in the art may conceive modifications and/or variations to the specific embodiments shown and described herein. Any such modifications or variations that fall within the purview of this description are intended to be included therein as well. It is understood that the description herein is intended to be illustrative only and is not intended to be limitative. Rather, the scope of the invention described herein is limited only by the claims appended hereto.

I claim:

1) A method of selecting articles applied to non-human animal from an article supplier who is remotely located from the non-human animal comprising of the steps:
A) measuring the all the contours of at least a portion of the surface area of the non-human animal which comes into contact with the article to be selected;
B) transmitting the measurements to supplier of the article remotely located from the animal; and
C) selecting an article based on the transmitted measurements.

2) A method of selecting articles of claim 1 wherein an additional step is transporting the selected article for further fitting to non-human animal.

3) A method of selecting articles of claim 1 wherein the measuring includes the additional step of recording the measurement.

4) A method of selecting articles of claim 3 wherein the measuring and recordation are accomplished by casting a mold of the contours of at least a portion of the contact surface area of the non-human animal to which the article is to be applied.

5) A method of selecting articles of claim 3 wherein the measuring and recordation are accomplished by electronically scanning the contours of at least a portion of contact surface area of the non-human animal to which the article is to be applied.

6) A method of selecting articles of claim 1 wherein the selected article is manufactured according the transmitted measurements.

7) A method of determining the compatibility of an article mounted on a non-human animal supplied by an article supplier comprising of the steps:
A) measuring the contours of at least a portion of the surface area of the non-human animal which comes into contact with an article to be selected to create data;
B) comparing the data obtained from measuring contours of the surface area for the non-human with data of a corresponding contact surface area of at least one article that is to be mounted on a non-human animal, and
C) eliminating from consideration those articles that would not have a compatible fit to a non-human animal based on the comparison of the data.

8) A method of selecting articles of claim 6 wherein the additional step comprises of to selecting those articles that would compatibly fit the scanned non-human animal based on data comparison.

9) A method of selecting articles of claim 6 wherein the additional step comprises of transporting an article, selected on the basis of suitable compatibly with the transmitted measurement data, so as to be fitted on the non-human animal.

10) A method of selecting articles of claim 6 wherein the comparison of data establishes that the article measurements do not compatibly match the transmitted measurement data.

11) A method of selecting articles of claim 6 wherein the additional step is transmitting the data to a article supplier who is remotely located from the site where the measurement was done.

12) A method of selecting articles of claim 6 wherein the measuring is accomplished by casting a mold of the contours of at least a portion of the contact surface area of the non-human animal to which the article is to be applied.

13) A method of selecting articles of claim 6 wherein the measuring are accomplished by electronically scanning the contours of at least a portion of contact surface area of the non-human animal to which the article is to be applied.

14) An apparatus for selecting articles mounted on non-human animal supplied by a remote supplier comprising of:
Kit that has a container whose interior holds measuring material and instructions for measuring and recording the contact surface areas of the non-human animal to which a selected article will be applied

15) An apparatus for selecting articles of claim 14 wherein the measuring material is comprised of material for making a mold.

16) An apparatus for selecting articles of claim 14 wherein the material for making a mold is further comprised of molding compound and protective compound.

17) An apparatus for selecting articles of claim 14 wherein the molding compound comprises of an element plaster-of-Paris.

18) An apparatus for selecting articles of claim 14 wherein the measuring material is an electronic scanning and recording instrument.

19) An apparatus for selecting articles of claim 14 wherein the instructions are in audio-visual electronic format.

20) An apparatus for selecting articles of claim 14 wherein the instruction contains sufficient data to allow the operation of the kit by untrained operators.
